(19) United States
(12) Patent Application Publication
(10) Pub. No.: US 2020/0307875 A1
(43) Pub. Date: Oct. 1, 2020

(54) Dual Function Storage Container Lid with Strainer

(71) Applicant: Eruj Abbasi, Plano, TX (US)

(72) Inventor: Eruj Abbasi, Plano, TX (US)

(21) Appl. No.: 16/371,123

(22) Filed: Apr. 1, 2019

(51) Int. Cl. B65D 51/24; B65D 47/20; B65D 43/16; A47J 47/04; A47J 47/01

(52) U.S. Cl. CPC B65D 51/24; B65D 47/20; A47J 47/01; A47J 47/04; B65D 43/161

(57) ABSTRACT

The present invention discloses a Food container lid with constrainer on one end and open lid on the other, due function lid. The food container includes a container body defining an interior space for holding a product therein and a lid configured to open and close the interior space.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to food storage lids, in particular to food containers which make it easy to pour things with ease and one lid fits all containers.

### Description of the Related Art

Food storage containers that provide a relatively airtight seal with a snap-on tight cover are relatively well known in the art, and are usually made of plastic material. Such food storage containers may be opaque or clear, the clear containers allowing the user to view the contents of the container.

Conventional storage containers, such as for storing food items, are commonly formed of generally or substantially rigid plastic configurations. Plastic containers of this type generally have a base and a lid that attaches to the base. The base typically has a bottom and a side wall that together define an interior storage space in the container. The lid can be attached to the base to cover the open top and to seal the storage space.

Such plastic containers are generally available in a variety of sizes to store or transport different volumes of food items. Each size container typically includes a corresponding lid sized to fit its associated container. A user will typically store empty containers in a kitchen cabinet or pantry area when not in use. When not being used, the lids often become separated from their associated container bases. Users have expressed frustration over lost or misplaced lids and the difficulty in finding the correct lid for a selected container.

In U.S. Pat. No. 4,836,370, issued on Jun. 6, 1989 to Alexander Bosshard, it has been suggested that a container be divided into two receiving chambers by some type of partition wall, such as may be accomplished by nesting one container within another, the purpose being to provide an opening in the partition wall between the two containers when one container is manipulated, so as to permit the intermixing of the respective materials placed in each container.

Another prior art container system is shown and described in U.S. Pat. No. 4,951,832 and includes a plurality of containers and lids, Each lid is sized to fit only its associated container. The inner surface of each lid is contoured either to snap-fit over the open top or onto the bottom of its respective container. The different sized containers can be stacked in a nested configuration, one inside the other, while the lids remain attached to the bottom of the corresponding container. The lids cannot be stacked together and the containers when full and in use cannot be stacked on top of one another in a stable arrangement.

U.S. Pat. No. 5,409,128 and includes stackable containers with lids. The containers have a first threaded segment on an outer surface near the open top adapted to engage with a first threaded segment on an inner surface of the lids so that the lids close off the open top of the container. Additionally, each lid includes a stepped portion of its top. The stepped portion includes a second threaded segment sized and shaped to mate with a second threaded segment formed within a lower rim of the container so that the lids can thread to the bottom of adjacent containers when stacked. A stable stack can be created, but the lids can not attach to one another for storage and the threaded connection method can be somewhat difficult to use, particularly with full containers.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a food container lid with constrainer on one end and open lid on the other.

It is also an object of the present invention to provide a container lid that can be easily removed for cleaning.

It is also an object of the present invention to provide a food storage container constructed of substantially transparent material so that the user is aware of the exact contents of the container without having to open it, thus protecting the contents from exposure.

It is also the objective of the invention to control dispensing of such lids so as to reduce wastage.

A further object is to provide an assembly that is simple, rapidly adjusted and easy to use.

A still further object is to provide an assembly that is economical in cost to manufacture.

It is a further object of the present invention to provide a few assembly which is of durable and reliable construction.

Still yet another object of the present invention is to provide a new and improved container lid which provides in the apparatuses and methods of the prior art some of the advantages thereof, while simultaneously overcoming some of the disadvantages normally associated therewith.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary front illustration of the lid.

FIG. 200 is another embodiment showing the use of lids for variety of products.

FIG. 300 shows an example of strainer in use.

FIG. 400 shows the open lid in use.

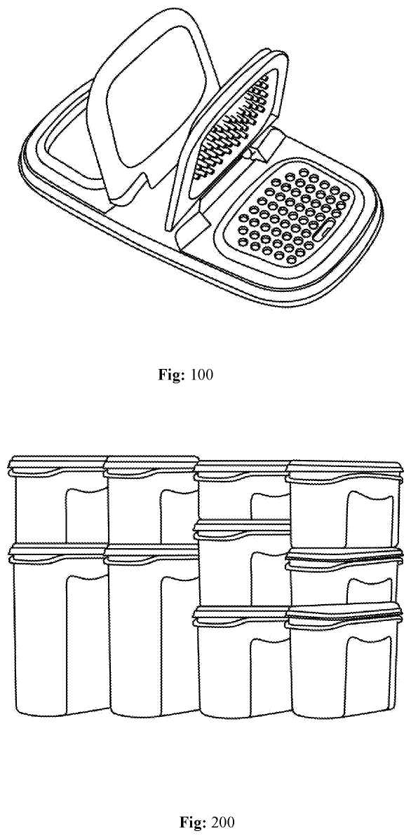

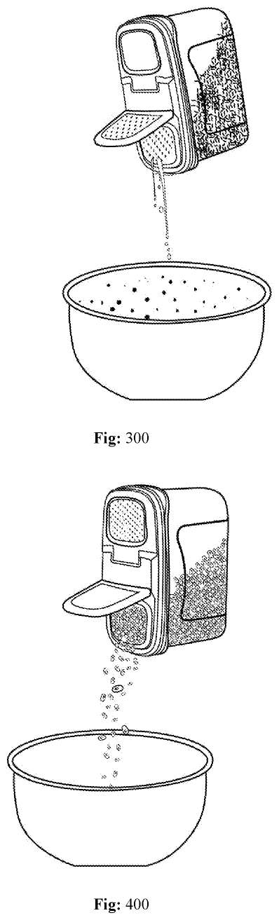

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide a plastic lid top surface be receptive to wide variety of materials such as food material i.e. pulses, Crafts, Sewing, Office Supplies, Garage And More. The lid also encompasses a strainer.

In one example, multiple container bases can be provided having varying storage space capacities with open tops that are identical in size and shape regardless of interior capacity. The lids can be identical one-size-fits-all or universal lids so that any lid can be used with any container base regardless of base storage capacity. In another example, the system can be provided having multiple different sized container bases, some of which have different sized open tops. In such an example, at least the container bases of the same open top size and shape can have a lid that is sized to fit the associated container bases. The disclosed container bases and lids can be formed of either a generally or substantially rigid plastic material and retain the same size and shape whether in use or not.

The lid may be substantially opaque or may be generally transparent. The lid may be formed from any suitable material that is FDA-compliant as a food-grade material for repeated use as a food contact product. The lid may be freezer-safe and/or microwave-safe.

The assembly is proposed to be made of durable material, which plastic. A key selling point of this architecture is its ease and rapidity of use.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A plastic food storage container comprising a constrainer on one end and open lid on the other.

2: A food container in accordance with claim 1, wherein the lid is formed from a material including firm plastic material.

3: A food storage container system wherein the container body of each of the containers is generally transparent and the lid is substantially opaque.
